(19) United States
(12) Patent Application Publication
(10) Pub. No.: US 2021/0229460 A1
(43) Pub. Date: Jul. 29, 2021

(54) THERMAL TRANSFER PRINTER AND PRINTING METHOD

(71) Applicant: Mitsubishi Electric Corporation, Tokyo (JP)

(72) Inventor: Yoshikuni NISHIMURA, Tokyo (JP)

(73) Assignee: Mitsubishi Electric Corporation, Tokyo (JP)

(21) Appl. No.: 17/050,810

(22) PCT Filed: Jul. 13, 2018
(86) PCT No.: PCT/JP2018/026497

§ 371 Date: Oct. 26, 2020

(51) Int. Cl. B41J 2/325; B41J 17/08; B41J 2/36

(52) U.S. Cl. CPC B41J 2/325; B41J 2/36; B41J 17/08

(57) ABSTRACT

A first image has a first superimposing portion being a rear end portion of the first image. A second image has a second superimposing portion being a front end portion of the second image. A filter processing unit performs filter processing on the first superimposing portion and the second superimposing portion. A panoramic image has a superimposing region. The filter processing is processing for reducing change in image quality of the superimposing region occurring in a situation where the second superimposing portion overlaps the first superimposing portion in a misaligned manner.

### TECHNICAL FIELD

The present invention relates to a thermal transfer printer having a function of printing a long image using two or more images and a printing method.

### BACKGROUND ART

In a sublimation type thermal transfer printer, heating an ink sheet by a thermal head performs printing processing for printing an image on paper. Hereinafter, yellow, magenta, and cyan are also referred to as “Y”, “M”, and “C”, respectively. Y, M, and C inks (dye) are applied to the ink sheet. Hereinafter, a Y component image is also referred to as “Y image”. In addition, hereinafter, an M component image is also referred to as “M image”. In addition, hereinafter, a C component image is also referred to as “C image”. In addition, hereinafter, of the paper, a region for printing an image is also referred to as “printing region”.

Specifically, the thermal transfer printer transfers the Y image, the M image, and the C image in the order of the Y image, the M image, and the C image to the printing region of the paper. Thus, a color image is printed in the printing region of the paper.

In recent years, a digital camera or a mobile terminal attached with a camera has been generally provided with a panoramic shooting mode for performing panoramic shooting. The mobile terminal is a mobile phone, a smartphone, or the like. Therefore, there is an increasing demand for performing panoramic printing for printing a long panoramic image obtained by panoramic shooting.

Hereinafter, the size of the panoramic image in the sub-scanning direction is also referred to as “panoramic size”. In addition, hereinafter, of the ink sheet, a region to be used in one-time printing processing is also referred to as “region Rt1”. The size of the region Rt1 is a normal printing size (for example, L size). The panoramic size is larger than the size of the region Rt1 in the sub-scanning direction.

Since the inkjet printer does not use an ink sheet, it is possible to easily print a panoramic image. However, the upper limit of the image size that can be printed by the thermal transfer printer in one-time printing processing is the size of the region Rt1. Therefore, in the thermal transfer printer, a special ink sheet is required if a panoramic image is printed in one-time printing processing.

Generally, in order to perform panoramic printing, first, for example, two images are acquired from the panoramic image. Then, in order to connect the two images to each other, printing the two images sequentially on paper achieves panoramic printing. It should be noted that in the panoramic printing, for example, two types of regions Rt1 for printing two images are used in the ink sheet.

Japanese Patent Application Laid-Open No. 2004-082610 and WO 2011/125134 A1 disclose a technique of printing a panoramic image by superimposing a front end portion of a second image on a rear end portion of a first image.

Japanese Patent Application Laid-Open No. 2004-082610 discloses a configuration that makes a boundary between the two images inconspicuous in the superimposing region where the front end portion of the second image overlaps with the rear end portion of the first image (hereinafter, also referred to as “related configuration A”).

Specifically, in the related configuration A, the density of the rear end portion of the first image gradually decreases from a leading edge toward a trailing edge of the rear end portion. In addition, the density of the front end portion of the second image gradually increases from a leading edge to a trailing edge of the front end portion. Thus, the print density in the superimposing region is adjusted. A print is an image printed on paper.

WO 2011/125134 A1 discloses another configuration that makes a boundary between the two images inconspicuous (hereinafter, also referred to as “related configuration B”). Specifically, in the related configuration B, the superimposed portion of the two images is shifted in the sub-scanning transfer direction for each color of Y, M, and C. In addition, the grayscale data of the superimposing portion is corrected for each line in the sub-scanning transfer direction based on a preset correction coefficient.

### SUMMARY

### Problem to be Solved by the Invention

When a panoramic image represented by a plurality of images including a first image and a second image is printed, a situation may occur in which a front end portion of the second image overlaps a rear end portion of the first image in a misaligned manner. In the situation, the image quality of the region for superimposing the front end portion on the rear end portion (hereinafter, also referred to as “superimposing region”) changes. The superimposing region is a region included in the panoramic image.

Thus, it is required to suppress the change in the image quality of the panoramic image (superimposing region) that occurs in a situation where the front end portion of the second image overlaps the rear end portion of the first image in a misaligned manner. It should be noted that the related configurations A and B cannot meet this requirement.

The present invention has been made to solve such a problem, and has an object to provide a thermal transfer printer or the like capable of suppressing the change in the image quality of the panoramic image that occurs in a situation where the front end portion of the second image overlaps the rear end portion of the first image in a misaligned manner.

### Means to Solve the Problem

In order to achieve the above object, a thermal transfer printer according to an aspect of the present invention performs printing processing of printing a panoramic image represented by a plurality of images including a first image and a second image on paper using an ink sheet. The first image has a first superimposing portion being a rear end portion of the first image. The second image has a second superimposing portion being a front end portion of the second image. The panoramic image is represented by at least the first image and the second image in a situation where the second superimposing portion is superimposed on the first superimposing portion. The thermal transfer printer includes: a filter processing unit configured to perform filter processing on the first superimposing portion and the second superimposing portion; a density adjusting unit configured to perform, on the first superimposing portion and the second superimposing portion, density processing of adjusting density of the first superimposing portion on which the filter processing is performed and density of the second superimposing portion on which the filter processing is performed; and a printing unit configured to perform the printing processing of printing, on the paper, the panoramic image to be represented by at least the first image and the second image in a situation where the second superimposing portion on which the density processing is performed is superimposed on the first superimposing portion on which the density processing is performed. The panoramic image has a superimposing region. The superimposing region is a region for superimposing the second superimposing portion on the first superimposing portion. The filter processing is processing configured to reduce change in image quality of the superimposing region occurring in a situation where the panoramic image is printed on the paper and a situation where the second superimposing portion overlaps the first superimposing portion in a misaligned manner.

### Effects of the Invention

According to the present invention, the first image has a first superimposing portion being a rear end portion of the first image. The second image has a second superimposing portion being a front end portion of the second image. The filter processing unit performs filter processing on the first superimposing portion and the second superimposing portion. The panoramic image has a superimposing region. The filter processing is processing for reducing change in image quality of the superimposing region occurring in a situation where the second superimposing portion overlaps the first superimposing portion in a misaligned manner.

Thus, it is possible to suppress change in the image quality of the panoramic image that occurs in a situation where the front end portion of the second image overlaps the rear end portion of the first image in a misaligned manner.

The objects, characteristics, aspects, and advantages of the present invention will become more apparent from the following detailed description and the accompanying drawings.

### BRIEF DESCRIPTION OF DRAWINGS

FIG. 1 is a block diagram showing a main configuration of a thermal transfer printer according to a first embodiment.

FIG. 2 is a diagram showing a configuration of a printing unit according to the first embodiment.

FIG. 3 is a diagram for illustrating an ink sheet.

FIG. 4A, FIG. 4B, and FIG. 4C are diagrams for illustrating a panoramic image.

FIG. 5 is a flowchart of print control processing according to the first embodiment.

FIG. 6A, FIG. 6B, and FIG. 6C are diagrams showing an image for illustrating the print control processing.

FIG. 7A, FIG. 7B, and FIG. 7C are diagrams showing an image for illustrating filter processing.

FIG. 8A, FIG. 8B, and FIG. 8C are diagrams showing a gradation state of a superimposing region.

FIG. 9 is a block diagram showing a main configuration of a thermal transfer printer according to a second embodiment.

FIG. 10 is a flowchart of print control processing A according to the second embodiment.

FIG. 11 is a block diagram illustrating a characteristic functional configuration of the thermal transfer printer.

FIG. 12 is a hardware configuration diagram of the thermal transfer printer.

FIG. 13A, FIG. 13B, FIG. 13C, and FIG. 13D are diagrams for illustrating processing in a comparative example.

FIG. 14A, FIG. 14B, and FIG. 14C are diagrams showing a gradation state of a superimposing region in a comparative example.

### DESCRIPTION OF EMBODIMENTS

Hereinafter, embodiments of the present invention will be described with reference to the drawings. In the following drawings, the same components are denoted by the same reference numerals. The names and functions of respective components denoted by the same reference numerals are the same. Therefore, a detailed description of a part of each component denoted by the same reference numeral may be omitted.

It should be noted that the dimensions, material, and shape of each component, relative arrangement of each component, and the like exemplified in the embodiments may be appropriately changed according to the configuration, various conditions, and the like of the apparatus to which the present invention is applied.

### First Embodiment

(Configuration)

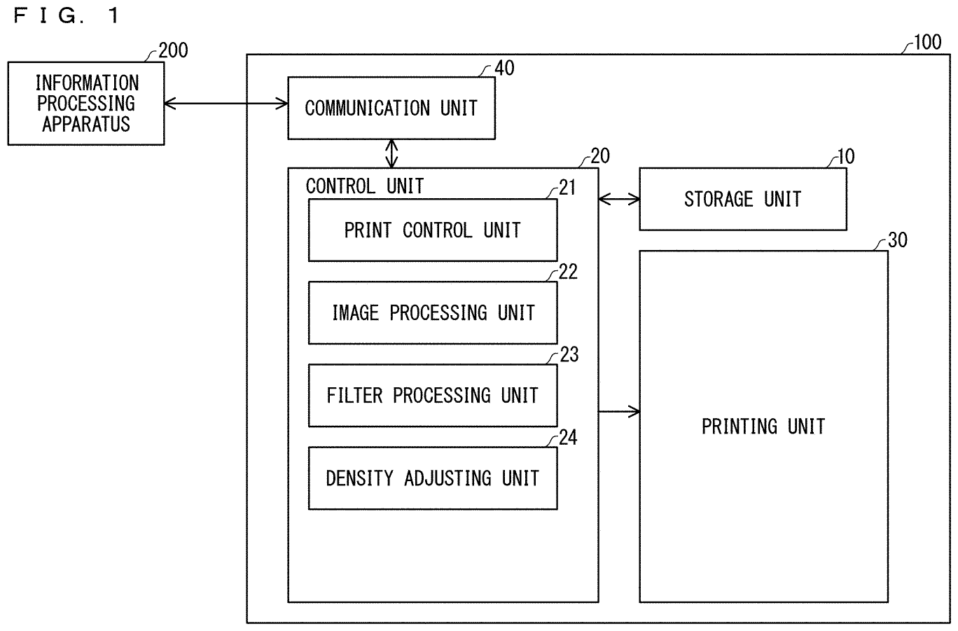

FIG. 1 is a block diagram showing a main configuration of a thermal transfer printer 100 according to the first embodiment. It should be noted that FIG. 1 does not show components (such as a power supply) not related to the first embodiment. In addition, FIG. 1 also shows an information processing apparatus 200 not included in the thermal transfer printer 100 for the sake of illustration. The thermal transfer printer 100 is a thermal transfer printer, for example. The thermal transfer printer 100 performs printing processing P for printing an image on paper, which will be described in detail below.

The information processing apparatus 200 is an apparatus that controls the thermal transfer printer 100. The information processing apparatus 200 is a personal computer (PC), for example. The information processing apparatus 200 is operated by a user. When the user performs a print execution operation on the information processing apparatus 200, the information processing apparatus 200 transmits print instructions and image data D1 to the thermal transfer printer 100. The print execution operation is an operation for causing the thermal transfer printer 100 to execute the printing processing P. In addition, the print instructions are instructions for causing the thermal transfer printer 100 to execute the printing processing P. The image data D1 is data on an image for being printed on paper. The image shown by the image data D1 includes a Y image, an M image, and a C image.

The thermal transfer printer 100 includes a storage unit 10, a control unit 20, a printing unit 30, and a communication unit 40. The communication unit 40 has a function of communicating with the information processing apparatus 200. The communication unit 40 performs communication using, for example, a universal serial bus (USB) interface. The print instructions and the image data D1 transmitted by the information processing apparatus 200 are transmitted to the control unit 20 via the communication unit 40.

The storage unit 10 is a memory that stores various kinds of data, programs, and the like. The storage unit 10 includes, for example, a volatile memory and a non-volatile memory. The volatile memory is a memory that temporarily stores data. The volatile memory is a random access memory (RAM), for example. The image data D1 is stored in the volatile memory.

The non-volatile memory stores a control program, initial set values, and the like. The non-volatile memory is a flash memory, for example.

The control unit 20 operates according to the control program stored in the storage unit 10. The control unit 20 performs various types of processing on each unit of the thermal transfer printer 100, which will be described in detail below. The control unit 20 is a processor such as a central processing unit (CPU), for example.

The control unit 20 includes a print control unit 21, an image processing unit 22, a filter processing unit 23, and a density adjusting unit 24. All or a part of the print control unit 21, the image processing unit 22, the filter processing unit 23, and the density adjusting unit 24 are program modules executed by the control unit 20, for example. In other words, all or a part of the print control unit 21, the image processing unit 22, the filter processing unit 23, and the density adjusting unit 24 are achieved by the control unit 20 performing various types of processing according to programs stored in a memory or the like.

It should be noted that all or a part of the print control unit 21, the image processing unit 22, the filter processing unit 23, and the density adjusting unit 24 may include a signal processing circuit including a hardware electric circuit.

The print control unit 21 has a function of controlling the printing unit 30, which will be described in detail below. The processing performed by each of the image processing unit 22, the filter processing unit 23, and the density adjusting unit 24 will be described below.

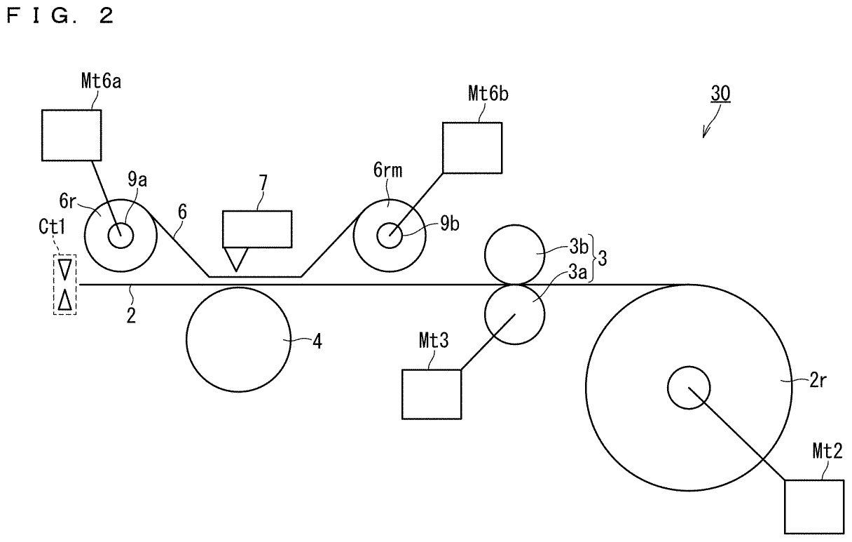

FIG. 2 is a diagram showing a configuration of the printing unit 30 according to the first embodiment. FIG. 2 shows a configuration of the printing unit 30 in a state where a roll paper 2r and an ink sheet 6 are mounted on the thermal transfer printer 100 (printing unit 30). The roll paper 2r is configured by long paper 2 being wound into a roll shape. A motor Mt2 is a motor for rotating the roll paper 2r. The print control unit 21 controls the motor Mt2. The motor Mt2 rotates the roll paper 2r so as to supply the paper 2 or take up the paper 2.

The ink sheet 6 is a long sheet. The ink sheet 6 is made of a material having heat resistance. The ink sheet 6 is made of a plastic film, for example.

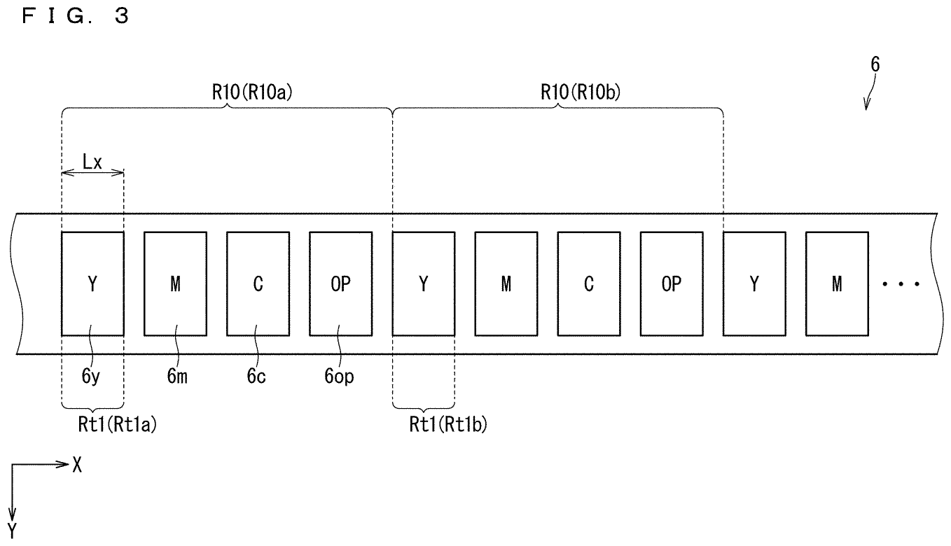

FIG. 3 is a diagram for illustrating the ink sheet 6. In FIG. 3, the X direction and the Y direction are orthogonal to each other. The X direction and the Y direction illustrated in the following drawings are also orthogonal to each other. Hereinafter, a direction including the X direction and a direction opposite to the X direction (−X direction) is also referred to as “X-axis direction”. In addition, hereinafter, a direction including the Y direction and a direction opposite to the Y direction (−Y direction) is also referred to as “Y-axis direction”. In addition, hereinafter, a plane including the X-axis direction and the Y-axis direction is also referred to as “XY plane”.

In FIG. 3, the −X direction is a direction toward an ink roll 6rm described below. In addition, in FIG. 3, the X direction is a direction toward an ink roll 6r described below. The detailed description of the ink sheet 6 will be given below.

With reference to FIG. 2 again, the printing unit 30 includes a thermal head 7, a conveyance roller pair 3, a platen roller 4, bobbins 9a and 9b, motors Mt2, Mt3, Mt6a, and Mt6b, and a cutter Ct1.

The thermal head 7 has a function of emitting heat.

The conveyance roller pair 3 is a roller pair for conveying the paper 2. The conveyance roller pair 3 includes a grip roller 3a and a pinch roller 3b. The motor Mt3 is a motor for rotating the grip roller 3a. The print control unit 21 controls the motor Mt3 so that the paper 2 is conveyed.

The motor Mt3 rotates the grip roller 3a with the paper 2 sandwiched by the grip roller 3a and the pinch roller 3b. Thus, the conveyance roller pair 3 conveys the paper 2.

One end of the ink sheet 6 is attached to the bobbin 9a. The other end of the ink sheet 6 is attached to the bobbin 9b. Winding one end portion of the ink sheet 6 around the bobbin 9a forms an ink roll 6r. Winding the other end portion of the ink sheet 6 around the bobbin 9b forms an ink roll 6rm.

The ink roll 6r is a roll for supplying the ink sheet 6. The ink roll 6rm is a roll for taking up the ink sheet 6.

The motor Mt6a is a motor for rotating the bobbin 9a (ink roll 6r). The motor Mt6b is a motor for rotating the bobbin 9b (ink roll 6rm). The print control unit 21 controls the motors Mt6a and Mt6b so that the ink sheet 6 is conveyed.

The bobbin 9b rotates so as to take up the ink sheet 6. That is, along with the rotation of the bobbin 9b, the ink roll 6rm rotates so as to take up the ink sheet 6. It should be noted that the ink roll 6r (bobbin 9a) also rotates along with the rotation of the ink roll 6rm. Therefore, as the ink roll 6rm takes up a part of the ink sheet 6, the ink roll 6r supplies the ink sheet 6 by the length of the taken-up ink sheet 6. It should be noted that in order for specified tension to occur in the ink sheet 6, the motor Mt6a rotates the bobbin 9a and the motor Mt6b rotates the bobbin 9b.

The platen roller 4 is provided so as to face a part of the thermal head 7. The platen roller 4 is movably configured so that the ink sheet 6 and the paper 2 can be sandwiched by the platen roller 4 and the thermal head 7. The platen roller 4 comes into contact with the thermal head 7 with the paper 2 and the ink sheet 6 interposed therebetween.

Hereinafter, the state of the platen roller 4 when the platen roller 4 is in contact with the thermal head 7 with the paper 2 and the ink sheet 6 interposed therebetween is also referred to as “platen contact state”. The platen contact state is a state in which the paper 2 and the ink sheet 6 are sandwiched between the platen roller 4 and the thermal head 7.

In the platen contact state, heating the ink sheet 6 by the thermal head 7 transfers the dye (ink) of the ink sheet 6 to the paper 2.

The cutter Ct1 has a function of cutting a part of the paper 2.

Referring to FIG. 3 again, in the ink sheet 6, ink regions R10 are periodically arranged along the longitudinal direction (X-axis direction) of the ink sheet 6.

The ink region R10 is provided with dyes 6y, 6m, and 6c and a protective material 6op. Each of the dyes 6y, 6m, and 6c and the protective material 6op is a transfer material transferred to the paper 2 by being heated by the thermal head 7. Each of the dyes 6y, 6m, and 6c shows a color to be transferred to the paper 2. The dyes 6y, 6m, and 6c show colors of yellow, magenta, and cyan, respectively. In addition, hereinafter, each of the Y dye, the M dye, and the C dye is also referred to as “color dye”. In addition, hereinafter, in the paper 2, the region for printing an image is also referred to as “printing region”.

In the printing processing P, unit printing processing is performed. In the unit printing processing, the ink sheet 6 and the paper 2 are simultaneously conveyed while the thermal head 7 heats the transfer material of the ink sheet 6 in the platen contact state. Thus, the transfer material is transferred to the printing region of the paper 2 for each line.

The unit printing processing described above is repeatedly performed on each of the dyes 6y, 6m, and 6c and the protective material 6op being transfer materials, whereby the dyes 6y, 6m, and 6c and the protective material 6op are transferred to the printing region of the paper 2 in the order of the dyes 6y, 6m, and 6c and the protective material 6op. As a result, an image is printed in the printing region of the paper 2, and the image is protected by the protective layer made of the protective material 6op.

The protective material 6op is made of a material that reduces the influence of ultraviolet rays, for example. Hereinafter, an object on which the image is printed in the printing region of the paper 2 is also referred to as “printed object”. The printed object is a part of the paper 2.

The cutter Ct1 cuts the paper 2 so that the printed object is cut off from the paper 2. Thus, the printed object is ejected from the thermal transfer printer 100.

Hereinafter, the image printed in the printing region of the paper 2 is also referred to as “image Gn”. In addition, hereinafter, the direction in which the paper 2 is conveyed is also referred to as “paper conveying direction”. In FIG. 3, the paper conveying direction is the X-axis direction including the X direction and the −X direction.

The direction in which the thermal transfer printer 100 prints an image on the paper 2 includes a main scanning direction and a sub-scanning direction. The sub-scanning direction is the paper conveying direction. In addition, the main scanning direction is a direction orthogonal to the sub-scanning direction. Hereinafter, the paper conveying direction is also referred to as “direction Drp”.

In addition, hereinafter, in the ink sheet 6, a region where each of the dyes 6y, 6m, and 6c and the protective material 6op is provided is also referred to as “region Rt1” or “Rt1” (see FIG. 3). The size of the region Rt1 corresponds to the size of one screen corresponding to the image Gn. Hereinafter, the size of the region Rt1 is also referred to as “one screen size”.

In addition, hereinafter, the length of the region Rt1 in the sub-scanning direction (X-axis direction) is also referred to as “length Lx” or “Lx”. The length Lx is predetermined. Therefore, when the ink sheet 6 is used, the upper limit of the length of the image Gn in the sub-scanning direction is the length Lx.

Hereinafter, the respective two adjacent ink regions R10 included in the ink sheet 6 are also referred to as an ink region R10a and an ink region R10b. In addition, hereinafter, the region Rt1 included in the ink region R10a is also referred to as “region Rt1a”. In addition, hereinafter, the region Rt1 included in the ink region R10b is also referred to as “region Rt1b”.

(Panoramic Image)

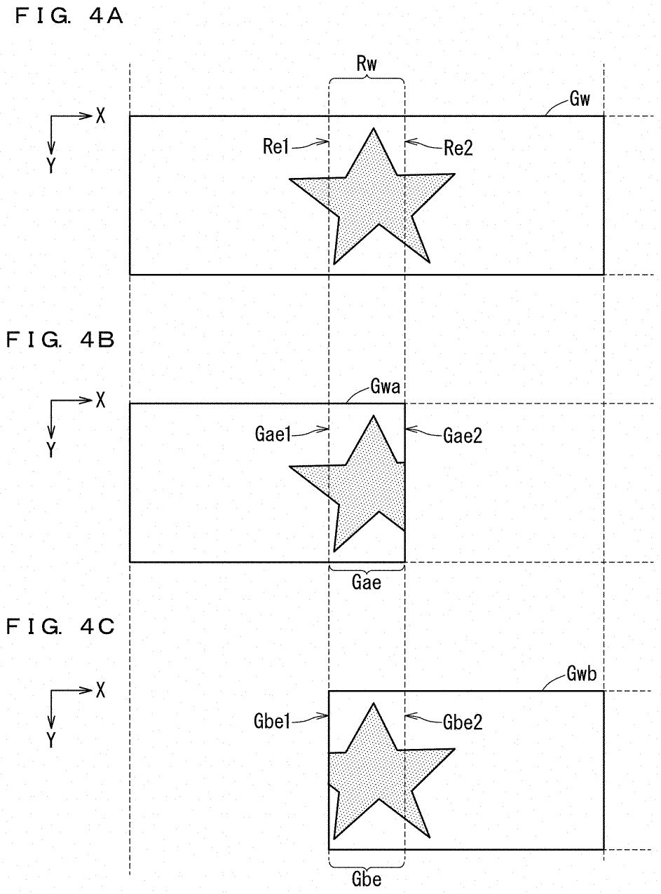

Next, the panoramic image will be described. The panoramic image is an image represented by two or more images. Hereinafter, the panoramic image is also referred to as “panoramic image Gw”. FIG. 4A, FIG. 4B, and FIG. 4C are diagrams for illustrating the panoramic image Gw. It should be noted that in FIG. 4A, FIG. 4B, and FIG. 4C, the main scanning direction is the Y-axis direction, and the sub-scanning direction is the X-axis direction.

In the present embodiment, in order to make the description easier to understand, an example of representing (generating) the panoramic image Gw will be described using two images. Hereinafter, the two images used for representing (generating) the panoramic image Gw are also referred to as “images Gwa and Gwb”. The panoramic image Gw includes the images Gwa and Gwb.

The panoramic image Gw of the present embodiment is an image represented by the image Gwa and the image Gwb, the details of which will be described below. The images Gwa and Gwb are printed on the paper 2 in the order of the images Gwa and Gwb. Although details will be described below, the thermal transfer printer 100 performs the printing processing P of printing the panoramic image Gw on the paper 2 using the ink sheet 6.

FIG. 4A is a diagram illustrating an example of the panoramic image Gw. The panoramic image Gw includes a plurality of pixels. Each pixel is represented by a gradation value (pixel value) indicating the density.

FIG. 4B shows an example of the image Gwa. The image Gwa has a superimposing portion Gae. The superimposing portion Gae is a rear end portion of the image Gwa. The superimposing portion Gae has a leading edge Gae1 and a trailing edge Gae2. The trailing edge Gae2 is a trailing edge of the image Gwa.

FIG. 4C shows an example of the image Gwb. The image Gwb has a superimposing portion Gbe. The superimposing portion Gbe is a front end portion of the image Gwb. The superimposing portion Gbe has a leading edge Gbe1 and a trailing edge Gbe2. The leading edge Gbe1 is a leading edge of the image Gwb.

It should be noted that the superimposing portion Gae of the image Gwa and the superimposing portion Gbe of the image Gwb are the same image.

In addition, the panoramic image Gw has a superimposing region Rw. The superimposing region Rw is a region for superimposing the superimposing portion Gbe of the image Gwb on the superimposing portion Gae of the image Gwa. The shape of the superimposing region Rw is rectangular. The superimposing region Rw has a leading edge Re1 and a trailing edge Re2. The leading edge Gae1 of the superimposing portion Gae corresponds to the leading edge Re1 of the superimposing region Rw. The trailing edge Gbe2 of the superimposing portion Gbe corresponds to the trailing edge Re2 of the superimposing region Rw.

Hereinafter, an image to be a target of printing on the paper 2 is also referred to as “target image”. Each of the images Gwa and Gwb is a target image. In addition, hereinafter, the state of the target image in a state where the target image is printed on the paper 2 is also referred to as “printed state”.

The superimposing portion Gae of the image Gwa in the printed state (rear end portion) and the superimposing portion Gbe of the image Gwb in the printed state (front end portion) are images of the superimposing region Rw. The image Gwa is an image printed by the n-th printing processing P. The “n” is a natural number of one or more. The image Gwb is an image printed by the (n+1)th printing processing P.

In the present embodiment, the n-th printing processing P and the (n+1)th printing processing P are sequentially performed so that the superimposing portion Gbe overlaps with the superimposing portion Gae, which will be described below in detail. In this case, a density step may occur in the superimposing region Rw due to the characteristics of the thermal transfer printer. That is, when the superimposing portion Gbe is simply superimposed on the superimposing portion Gae, a change in density occurs in the superimposing region Rw.

Thus, in the present embodiment, image processing is performed to make the density step (density change) inconspicuous. In the present embodiment, the density processing for reducing the density change in the superimposing region Rw that occurs when the superimposing portion Gbe is superimposed on the superimposing portion Gae is performed on the superimposing portion Gae and the superimposing portion Gbe, which will be described in detail below.

(Operation of Printer)

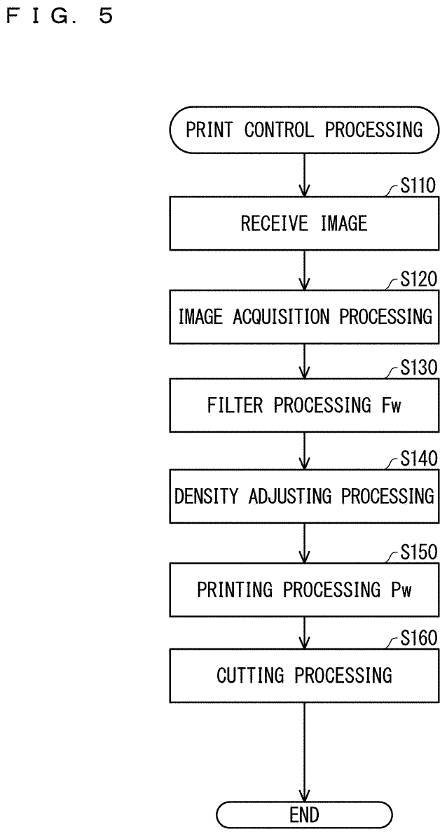

Next, processing performed by the thermal transfer printer 100 (hereinafter, also referred to as “print control processing”) will be described. FIG. 5 is a flowchart of the print control processing according to the first embodiment.

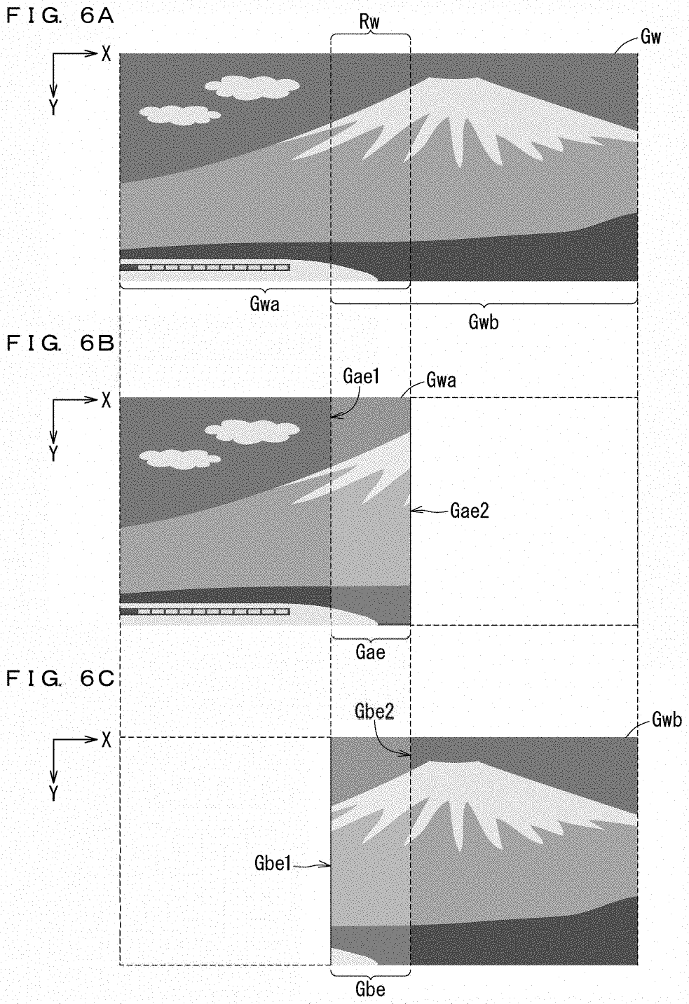

Here, the following premise Pm1 is considered. On the premise Pm1, the information processing apparatus 200 transmits the print instructions and the image data D1 indicating the panoramic image Gw in FIG. 6A to the thermal transfer printer 100. The panoramic image Gw in FIG. 6A includes the image Gwa and the image Gwb.

Hereinafter, the state of the panoramic image Gw to be transmitted to the thermal transfer printer 100 by the information processing apparatus 200 is also referred to as “original state”. The panoramic image Gw to be transmitted to the thermal transfer printer 100 is the panoramic image Gw in the original state.

In the print control processing on the premise Pm1, first, the communication unit 40 of the thermal transfer printer 100 receives the panoramic image Gw in the original state and transmits the panoramic image Gw to the control unit 20. Thus, the control unit 20 receives the panoramic image Gw (step S110). The control unit 20 causes the storage unit 10 to store the received panoramic image Gw.

It should be noted that when the size of the panoramic image Gw stored in the storage unit 10 is not a predetermined specified size, size adjusting processing is performed. In the size adjusting processing, the image processing unit 22 enlarges or reduces the panoramic image Gw so that the size of the panoramic image Gw is the specified size.

Hereinafter, an image that can be generated by one-time printing processing P is also referred to as “unit image”. The unit image is an image that can be generated using one ink region R10.

Next, in step S120, image acquisition processing is performed. In the image acquisition processing on the premise Pm1, the image processing unit 22 acquires the image Gwa and the image Gwb as the unit images from the panoramic image Gw in the original state in FIG. 6A.

The size of each of the images Gwa and Gwb is one screen size (size of the region Rt1). It should be noted that the size of each of the images Gwa and Gwb is not limited to one screen size. The size of each of the images Gwa and Gwb may be the smallest size that the thermal transfer printer 100 can print, for example.

Next, in step S130, filter processing Fw is performed. In the filter processing Fw, the filter processing unit 23 performs filter processing on the superimposing portion Gae as an image and the superimposing portion Gbe as an image (step S130). Each of the filter processing performed on the superimposing portion Gae as an image and the filter processing performed on the superimposing portion Gbe as the image is blurring processing. The blurring processing is processing for reducing the sharpness of the image. Since the blurring processing is a well-known technique, detailed description will be omitted.

In the following, the blurring processing will be briefly described. The blurring processing is processing of reducing a high-frequency component included in the frequency components of the image. The blurring processing is processing of removing a high-frequency component in the spatial frequency spectrum of the image, which is obtained by performing a two-dimensional Fourier transform on the image, for example.

When the blurring processing is performed in a situation where high-frequency components corresponding to the edge portion or the like exist in the superimposing portion Gae and the superimposing portion Gbe, the edge portion changes to the density low change portion. The density low change portion is an image in which the difference (change) in density (gradation value) between a plurality of adjacent pixels is small.

Hereinafter, the amount of reduction in the sharpness of the image caused by performing the blurring processing on the image is also referred to as “blurring degree”. The higher the blurring degree, the lower the sharpness of the image on which the blurring processing is performed. On the other hand, the lower the blurring degree, the higher the sharpness of the image on which the blurring processing is performed. The blurring degree can be changed by changing the size of the range of high-frequency components to be removed.

It should be noted that the blurring processing is not limited to the processing using frequency components. The blurring processing may be processing of changing the gradation values of a plurality of pixels forming an image using a plurality of coefficients represented by a filter matrix, for example. The filter matrix is a matrix with 3 rows and 3 columns, for example. In the blurring processing using the filter matrix, the blurring degree can be changed by changing the plurality of coefficients included in the filter matrix.

Hereinafter, the state of the superimposing portions Gae and Gbe on which the filter processing has been performed is also referred to as “filtered state”.

Next, in step S140, density adjusting processing is performed. In the density adjusting processing, the density adjusting unit 24 performs density processing of adjusting the density of the superimposing portion Gae in the filtered state and the density of the superimposing portion Gbe in the filtered state on the superimposing portion Gae and the superimposing portion Gbe.

Specifically, in the density adjusting processing, the density adjusting unit 24 performs, on the superimposing portion Gae and the superimposing portion Gbe, density processing for reducing the density change in the superimposing region Rw occurring when the superimposing portion Gbe in the filtered state is superimposed on the superimposing portion Gae in the filtered state. That is, the density adjusting processing is processing of correcting the superimposing portion Gae and the superimposing portion Gbe so as to suppress a decrease in image quality of the superimposing region Rw, which occurs when the superimposing portion Gbe is superimposed on the superimposing portion Gae.

The density adjusting processing is processing performed in the related configuration B described above, for example. In the following, the density adjusting processing will be briefly described.

Hereinafter, an image whose density gradually changes in the sub-scanning direction is also referred to as “gradation image”. In addition, hereinafter, the superimposing portion Gae in which the density of the superimposing portion Gae gradually decreases from the leading edge Gae1 toward the trailing edge Gae2 of the superimposing portion Gae is also referred to as “superimposing portion Gar”. The superimposing portion Gar is a gradation image. In addition, hereinafter, the superimposing portion Gbe in which the density of the superimposing portion Gbe gradually increases from the leading edge Gbe1 toward the trailing edge Gbe2 of the superimposing portion Gbe is also referred to as “superimposing portion Gbr”. The superimposing portion Gbr is a gradation image.

More specifically, in the density adjusting processing, the density adjusting unit 24 performs density processing for correcting the densities (gradation values) of a plurality of pixels included in the superimposing portion Gae so that the superimposing portion Gae in the filtered state in the image Gwa becomes the superimposing portion Gar (gradation image).

In addition, the density adjusting unit 24 performs density processing for correcting the densities (gradation values) of a plurality of pixels included in the superimposing portion Gbe so that the superimposing portion Gbe in the filtered state in the image Gwb becomes the superimposing portion Gbr (gradation image).

That is, in the situation where the superimposing portion Gbe in the filtered state is superimposed on the superimposing portion Gae in the filtered state, the density adjusting processing corrects the superimposing portion Gae and the superimposing portion Gbe so as to be capable of reproducing a color tone the same as the color tone of the superimposing region Rw included in the panoramic image Gw in the original state described above.

Performing the density adjusting processing on the premise Pm1 allows the superimposing portion Gae in FIG. 6B and the superimposing portion Gbe in FIG. 6C to be obtained. It should be noted that the superimposing portion Gae in FIG. 6B and the superimposing portion Gbe in FIG. 6C show simple images in which the density of the entire superimposing region Rw in FIG. 6A is reduced. However, in reality, the superimposing portion Gae in FIG. 6B is the superimposing portion Gar (gradation image), and the superimposing portion Gbe in FIG. 6C is the superimposing portion Gbr (gradation image).

Hereinafter, the state of the superimposing portions Gae and Gbe on which the density processing (density adjusting processing) has been performed is also referred to as “density adjusted state”. In addition, hereinafter, the state of the image Gwa having the superimposing portion Gae in the density adjusted state is also referred to as “corrected state”. In addition, hereinafter, the state of the image Gwb having the superimposing portion Gbe in the density adjusted state is also referred to as “corrected state”.

Next, the control unit 20 generates print data using the images Gwa and Gwb. The print data is control data for printing the images Gwa and Gwb on the paper 2. The control data is data for performing heating control of the thermal head 7, control of a drive mechanism (for example, motor) of the printing unit 30, and the like.

In step S150, the printing unit 30 performs printing processing Pw according to the print data described above. In the printing processing Pw, k-times printing processing P is performed. The “k” is an integer of one or more. The printing processing Pw is processing of printing the panoramic image Gw represented by at least the image Gwa and the image Gwb on the paper 2 in a situation where the superimposing portion Gbe in the density adjusted state is superimposed on the superimposing portion Gae in the density adjusted state. In the printing processing Pw on the premise Pm1, the printing processing P is performed twice.

Hereinafter, the printing region for printing the image Gwa in the paper 2 is also referred to as “printing region Ra”. In addition, hereinafter, the printing region for printing the image Gwb in the paper 2 is also referred to as “printing region Rb”.

Specifically, in the printing processing Pw on the premise Pm1, the print control unit 21 controls the printing unit 30 so that the first printing processing P and the second printing processing P are performed in the order of the first printing processing P and the second printing processing P. The first printing processing P is processing for printing the image Gwa in the corrected state on the printing region Ra of the paper 2 using the ink region R10a (region Rt1a) of the ink sheet 6. In addition, the second printing processing P is processing for printing the image Gwb in the corrected state on the printing region Rb of the paper 2 using the ink region R10b (region Rt1b).

In addition, the print control unit 21 controls the printing unit 30 so that the operation of printing the image Gwb is performed in the second printing processing P. Specifically, the print control unit 21 controls the printing unit 30 so that in the second printing processing P, a printing operation of the image Gwb for superimposing the superimposing portion Gbe of the image Gwb in the corrected state on the superimposing portion Gae of the image Gwa in the corrected state. It should be noted that since the printing processing P has been described above, the description thereof will be omitted.

Performing the printing processing Pw on the premise Pm1 prints the panoramic image Gw on the paper 2. Hereinafter, the state in which the panoramic image Gw is printed on the paper 2 is also referred to as “superimposition printed state”. The panoramic image Gw in the superimposition printed state is represented by at least the image Gwa and the image Gwb in a situation where the superimposing portion Gbe is superimposed on the superimposing portion Gae. The superimposing region Rw of the panoramic image Gw in the superimposition printed state is a region in which the superimposing portion Gbe overlaps the superimposing portion Gae.

Next, in step S160, cutting processing is performed. Hereinafter, in the paper 2, the portion on which the panoramic image Gw is printed is also referred to as “printed object”. In the cutting processing, the cutter Ct1 cuts the paper 2 so that the printed object is cut off from the paper 2. Then, the printed object is ejected from the thermal transfer printer 100. Then, the print control processing ends.

Here, a comparative example to be compared with the present embodiment will be described. Hereinafter, print control processing in the comparative example is also referred to as “print control processing N”. The print control processing N differs from the print control processing in FIG. 5 in that the filter processing (step S130) is not performed. Pieces of processing other than that processing in the print control processing N are the same as those in the print control processing in FIG. 5. Hereinafter, the position where the image is printed is also referred to as “printed position”.

It should be noted that when the printing processing Pw described above is performed, misalignment of the printed position of the target image (both or one of the images Gwa and Gwb) may occur. That is, a state where the entire superimposing portion Gbe of the image Gwb does not overlap the entire superimposing portion Gae of the image Gwa may occur.

Hereinafter, in a state where the panoramic image Gw is printed on the paper 2 (superimposition printed state), a state where the entire superimposing portion Gbe does not overlap the entire superimposing portion Gae is also referred to as “misalignment state”. In addition, hereinafter, in the superimposition printed state, a state in which the entire superimposing portion Gbe overlaps the entire superimposing portion Gae is also referred to as “normal state”. That is, the superimposition printed state includes a normal state and a misalignment state.

The misalignment state is a state where, in the superimposition printed state, the entire superimposing portion Gbe in FIG. 6C does not overlap the entire superimposing portion Gae in FIG. 6B, for example. That is, the misalignment state is a state where the misalignment of the printed position of both or one of the images Gwa and Gwb occur.

The normal state is a state where, in the superimposition printed state, the entire superimposing portion Gbe in FIG. 6C overlaps the entire superimposing portion Gae in FIG. 6B, for example. That is, the normal state is a state where the misalignment of the printed positions of the images Gwa and Gwb does not occur.

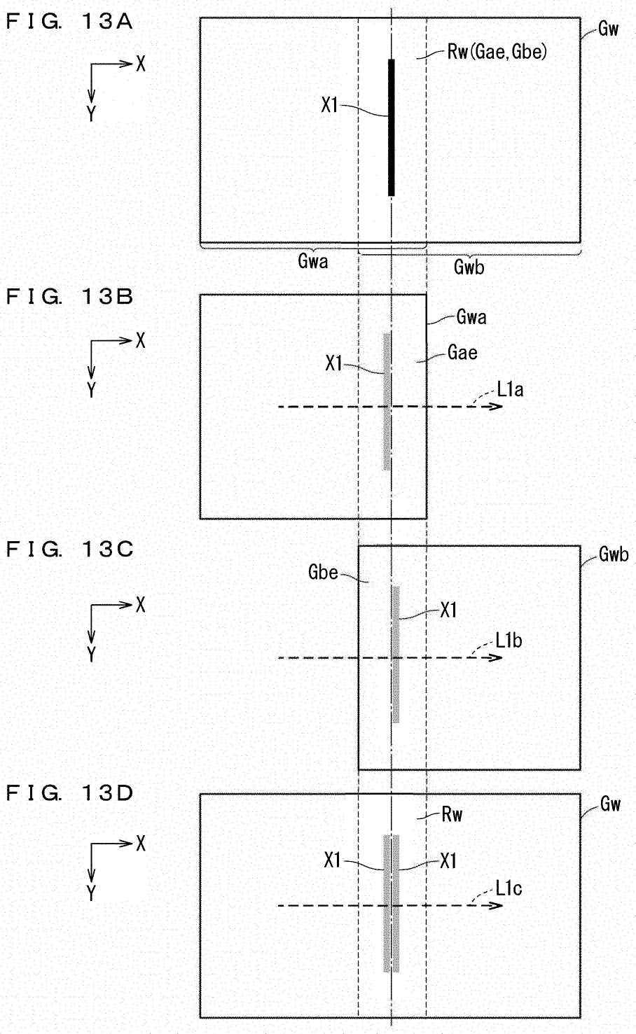

Here, the following premise Pm2 is considered. On the premise Pm2, the panoramic image Gw in the original state to be processed is the panoramic image Gw in FIG. 13A. The panoramic image Gw in FIG. 13A includes the superimposing region Rw indicating one line X1. In addition, on the premise Pm2, the misalignment of the printed positions of the images Gwa and Gwb occurs. That is, on the premise Pm2, the misalignment state occurs.

In the print control processing N on the premise Pm2, the image Gwa and the image Gwb are acquired from the panoramic image Gw in FIG. 13A by the image acquisition processing. The superimposing portion Gae of the image Gwa shows one line X1. In addition, the superimposing portion Gbe of the image Gwb shows one line X1.

Then, in the density adjusting processing on the premise Pm2, the density processing is performed on the superimposing portion Gae and the superimposing portion Gbe. Next, the printing processing Pw on the premise Pm2 is performed. Thus, the images Gwa and Gwb in the printed state and the panoramic image Gw in the superimposition printed state are obtained.

The image Gwa (superimposing portion Gae) in the printed state on the premise Pm2 becomes the image Gwa (superimposing portion Gae) in FIG. 13B. It should be noted that the printed position of the image Gwa in FIG. 13B is misaligned.

In addition, the image Gwb (superimposing portion Gbe) in the printed state on the premise Pm2 becomes the image Gwb (superimposing portion Gbe) in FIG. 13C. It should be noted that the printed position of the image Gwb in FIG. 13C is misaligned. In addition, the panoramic image Gw in the superimposition printed state on the premise Pm2 becomes the panoramic image Gw in FIG. 13D.

The position of the line X1 indicated by the image Gwa (superimposing portion Gae) in the printed state in FIG. 13B exists at a position misaligned from the position of the line X1 in FIG. 13A. The position of the line X1 indicated by the image Gwb (superimposing portion Gbe) in the printed state in FIG. 13C exists at a position misaligned from the position of the line X1 in FIG. 13A.

The panoramic image Gw in FIG. 13D is represented by the image Gwa in FIG. 13B and the image Gwb in FIG. 13C in a situation where the superimposing portion Gbe in FIG. 13C is superimposed on the superimposing portion Gae in FIG. 13B. Therefore, two lines X1 are shown in the superimposing region Rw of the panoramic image Gw in the superimposition printed state in FIG. 13D.

Hereinafter, the image to be represented by the superimposing portion Gae and the superimposing portion Gbe in the misalignment state is also referred to as “superimposition image Gwc”. The superimposing region Rw (image) of the panoramic image Gw in FIG. 13D is the superimposition image Gwc. The superimposing region Rw (superimposition image Gwc) in FIG. 13D is an image in which the superimposing portion Gbe in FIG. 13C is superimposed on the superimposing portion Gae in FIG. 13B.

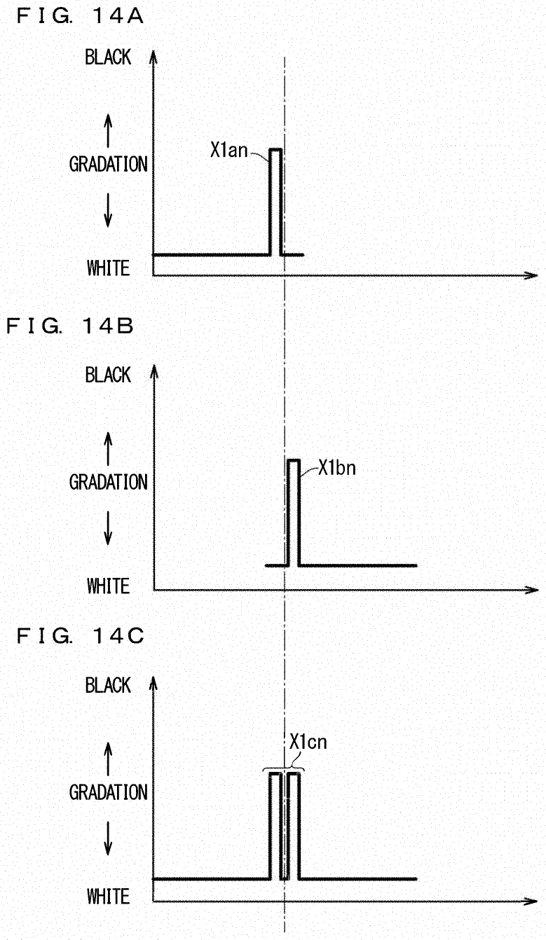

FIG. 14A is a diagram showing a gradation state of the line X1 along the arrow line L1a in FIG. 13B with a gradation line X1an. In FIG. 14A, the vertical axis represents a gradation value, and the horizontal axis represents a position in the X-axis direction. FIG. 14B is a diagram showing a gradation state of the line X1 along the arrow line L1b in FIG. 13C with a gradation line X1bn. FIG. 14C is a diagram showing a gradation state of the two lines X1 along the arrow line L1c in FIG. 13D with a gradation line X1cn. The gradation line X1cn shows two peaks.

Thus, when the print control processing N not including the filter processing is performed, the occurrence of misalignment at the printed positions of the images Gwa and Gwb represents the one line X1 shown by the panoramic image Gw in the original state as two lines X1 as shown in FIG. 13D.

That is, when the print control processing N of the comparative example is performed, the occurrence of misalignment at the printed positions of the images Gwa and Gwb generates a streak in the superimposing region Rw of the panoramic image Gw in the superimposition printed state. In other words, in a situation where the panoramic image Gw is printed on the paper 2, and in a situation where the superimposing portion Gbe overlaps the superimposing portion Gae in a misaligned manner, the image quality of the superimposing region Rw deteriorates (changes).

Hereinafter, the situation where the panoramic image Gw is printed on the paper 2, and the situation where the superimposing portion Gbe overlaps the superimposing portion Gae in a misaligned manner is also referred to as “printing misalignment situation”. In the printing misalignment situation, the image quality of the superimposing region Rw significantly deteriorates. Hereinafter, a portion showing streaks, unevenness, and the like is also referred to as “low image quality portion”.

On the other hand, in the print control processing of the present embodiment, the filter processing (blurring processing) is performed on the superimposing portion Gae and the superimposing portion Gbe. Therefore, performing the print control processing on the premise Pm2 allows the following images Gwa and Gwb in the printed state and the panoramic image Gw in the superimposition printed state to be obtained.

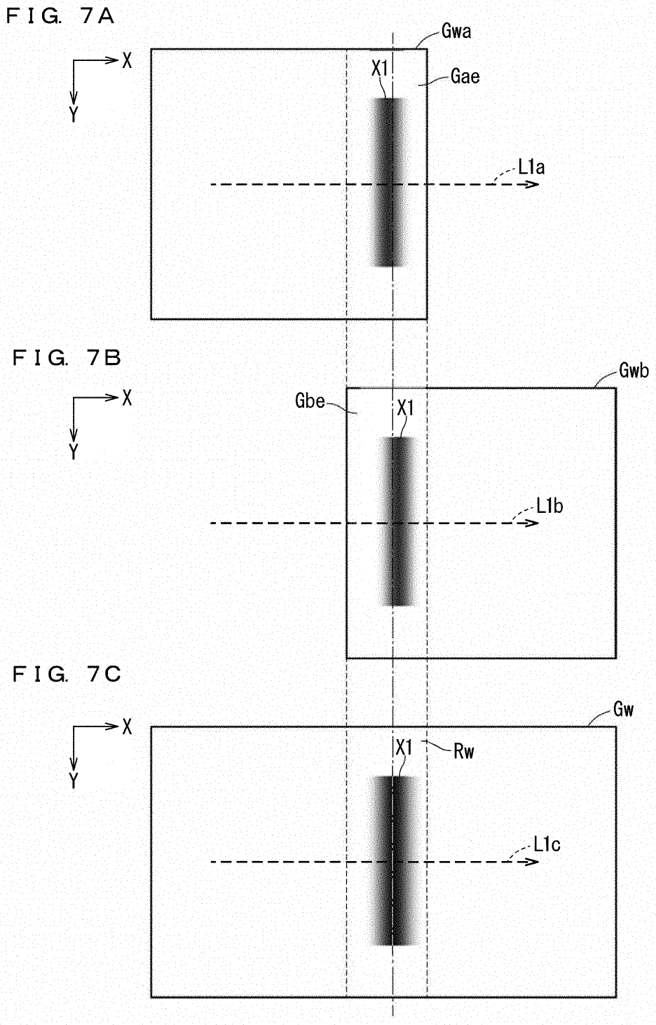

The image Gwa (superimposing portion Gae) in the printed state on the premise Pm2 becomes the image Gwa (superimposing portion Gae) in FIG. 7A. It should be noted that the printed position of the image Gwa in FIG. 7A is misaligned.

In addition, the image Gwb (superimposing portion Gbe) in the printed state on the premise Pm2 becomes the image Gwb (superimposing portion Gbe) in FIG. 7B. It should be noted that the printed position of the image Gwb in FIG. 7B is misaligned. In addition, the panoramic image Gw in the superimposition printed state on the premise Pm2 becomes the panoramic image Gw in FIG. 7C.

The line X1 indicated by the image Gwa (superimposing portion Gae) in FIG. 7A corresponds to the one obtained by performing the blurring processing on the line X1 in FIG. 13B. The line X1 indicated by the image Gwa (superimposing portion Gae) in FIG. 7B corresponds to the one obtained by performing the blurring processing on the line X1 in FIG. 13C.

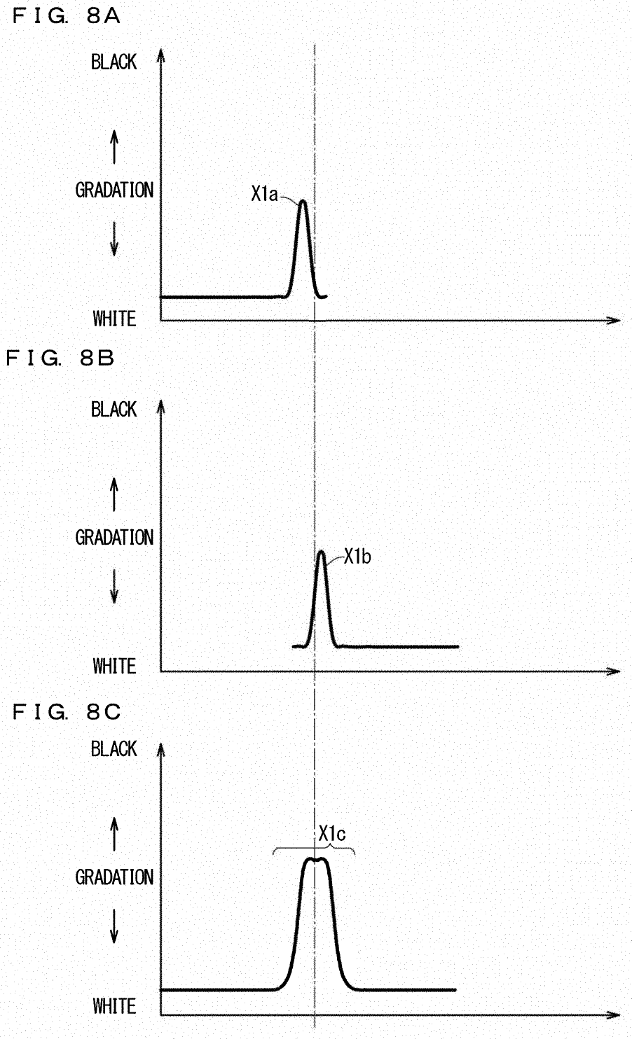

FIG. 8A is a diagram showing a gradation state of the line X1 along the arrow line L1a in FIG. 7A with a gradation line X1a. FIG. 8B is a diagram showing a gradation state of the line X1 along the arrow line L1b in FIG. 7B with a gradation line X1b. The gradation lines X1a and X1b show peaks having wide bases instead of rectangular peaks as compared with the gradation line X1an in FIG. 14A and the gradation line X1bn in FIG. 14B.

It should be noted that the panoramic image Gw in FIG. 7C is represented by the image Gwa in FIG. 7A and the image Gwb in FIG. 7B in a situation where the superimposing portion Gbe in FIG. 7B is superimposed on the superimposing portion Gae in FIG. 7A.

Therefore, one line X1 is shown in the superimposing region Rw of the panoramic image Gw in the superimposition printed state in FIG. 7C. The superimposing region Rw in FIG. 7C is an image in which the superimposing portion Gbe in FIG. 7B is superimposed on the superimposing portion Gae in FIG. 7A.

It should be noted that FIG. 8C is a diagram showing a gradation state of the line X1 along the arrow line L1c in FIG. 7C with a gradation line X1c. The gradation line X1c shows one peak instead of two peaks as compared with the gradation line X1cn in FIG. 14C.

That is, when the print control processing (filter processing) of the present embodiment is performed, even if misalignment at the printed positions of the images Gwa and Gwb occurs, the one line X1 indicated by the panoramic image Gw in the original state is represented as one line X1 instead of the two lines X1 in FIG. 13D (see FIG. 7C).

In other words, when the print control processing (filter processing) is performed, even if misalignment at the printed positions of the images Gwa and Gwb occurs, the effect of the filter processing (blurring processing) can represent the two lines X1 indicated by the superimposing region Rw in FIG. 13D as one line X1 (see FIG. 7C). That is, the effect of the filter processing (blurring processing) makes it is possible to suppress the occurrence of a low image quality portion (streak) in the superimposing region Rw of the panoramic image Gw in the superimposition printed state.

Therefore, in the print control processing, the filter processing (blurring processing) performed on the superimposing portions Gae and Gbe is processing of suppressing the deterioration of the image quality of the superimposing region Rw occurring in the printing misalignment situation. That is, the filter processing (blurring processing) performed on the superimposing portions Gae and Gbe is processing of reducing change in image quality of the superimposing region Rw occurring in a printing misalignment situation.

That is, in the print control processing of the present embodiment, since the filter processing (blurring processing) is performed, even if misalignment of the printed positions of the images Gwa and Gwb occurs, it is possible to suppress decrease in image quality of the superimposing region Rw of the panoramic image Gw in the superimposition printed state.

(Summary)

As described above, according to the present embodiment, the image Gwa has the superimposing portion Gae being the rear end portion of the image Gwa. The image Gwb has the superimposing portion Gbe being the front end portion of the image Gwb. The filter processing unit 23 performs the filter processing on the superimposing portion Gae and the superimposing portion Gbe. The panoramic image Gw has the superimposing region Rw. The filter processing is processing for reducing change in image quality of the superimposing region Rw occurring in a situation where the superimposing portion Gbe overlaps the superimposing portion Gae in a misaligned manner.

Thus, it is possible to suppress change in the image quality of the panoramic image occurring when the front end portion of the second image (image Gwb) overlaps the rear end portion of the first image (image Gwa) in a misaligned manner.

In addition, in the present embodiment, the filter processing (blurring processing) is performed on the superimposing portion Gae of the image Gwa and the superimposing portion Gbe of the image Gwb. Thus, even if misalignment of the printed positions of the images Gwa and Gwb occurs, the misalignment of the printed positions becomes inconspicuous, and it is possible to suppress the occurrence of a low image quality portion (streak) in the superimposing region Rw of the panoramic image Gw in the superimposition printed state. Therefore, even if misalignment of the printed positions of the images Gwa and Gwb occurs, it is possible to suppress decrease in the image quality of the superimposing region Rw of the panoramic image Gw in the superimposition printed state. That is, it is possible to obtain an effect that a high quality print can be stably obtained.

It should be noted that when the panoramic image Gw is printed on paper, it is necessary to accurately superimpose the superimposing portion Gbe on the superimposing portion Gae. When misalignment of the printed positions of the images Gwa and Gwb occurs, there is a problem that a low image quality portion (streak) is generated in the superimposing region Rw and decrease in the image quality of the superimposing region Rw occurs.

Thus, the thermal transfer printer 100 of the present embodiment has a configuration for producing the above-described effect. Therefore, the above problem can be solved by the thermal transfer printer 100 of the present embodiment.

It should be noted that in the present embodiment, the number of images for representing the panoramic image Gw in the superimposition printed state is set to 2, but the number is not limited to this. The number of images for representing the panoramic image Gw in the superimposition printed state may be three or more. That is, the panoramic image Gw may be an image represented by a plurality of images including the image Gwa and the image Gwb.

For example, in a configuration where the number of images for representing the panoramic image Gw in the superimposition printed state is 3, three images are acquired from the panoramic image Gw in the original state. In the configuration, printing the three images so that parts of the three images overlap each other prints the panoramic image Gw. It should be noted that in the configuration, the front end portion and rear end portion of the second image are used as superimposing portions.

<First Modification>

Hereinafter, the configuration of the first embodiment is also referred to as “configuration Ct1”. In addition, hereinafter, the configuration of the present modification is also referred to as “configuration Ctm1”. The configuration Ctm1 is a configuration for performing filter processing with different characteristics on the superimposing portion of each image acquired from the panoramic image Gw in the original state.

In the configuration Ct1, it is possible to suppress the occurrence of a low image quality portion (streak) in the superimposing region Rw. However, in the configuration Ct1, the sharpness of the superimposing region Rw of the panoramic image Gw in the superimposition printed state is lower than the sharpness of the superimposing region Rw of the panoramic image Gw in the original state. That is, in the configuration Ct1, the sharpness of the superimposing region Rw of the panoramic image Gw in the superimposition printed state is low. Therefore, in the panoramic image Gw in the superimposition printed state, the sharpness of the superimposing region Rw and the sharpness of the regions other than the superimposing region Rw are different. Therefore, depending on the content of the panoramic image Gw in the original state, a step in density (a joint) may be conspicuous at the leading edge and the trailing edge of the superimposing region Rw.

Thus, in the configuration Ctm1, in the filter processing Fw, filter processing with different characteristics is performed on the superimposing portion Gae and the superimposing portion Gbe. Hereinafter, the filter processing performed on the superimposing portion Gae is also referred to as “filter processing Fa”. In addition, hereinafter, the filter processing performed on the superimposing portion Gbe is also referred to as “filter processing Fb”.

The print control processing in the configuration Ctm1 of the present modification is different from the print control processing in the configuration Ct1 only in the filter processing Fw. Since pieces of processing other than that processing in the print control processing in the configuration Ctm1 are the same as those in the print control processing in the configuration Ct1, detailed description will not be repeated.

In the filter processing Fw in FIG. 5 in the configuration Ctm1, the filter processing unit 23 performs the filter processing Fa on the superimposing portion Gae, and the filter processing unit 23 performs the filter processing Fb on the superimposing portion Gbe. The characteristic of the filter processing performed by the filter processing unit 23 on the superimposing portion Gae and the characteristic of the filter processing performed by the filter processing unit 23 on the superimposing portion Gbe are different from each other.

The filter processing Fa is sharpening filter processing, for example. The sharpening filter processing is processing of amplifying a high frequency component of an image. That is, the sharpening filter processing is processing of emphasizing the edge of the image. The filter processing Fb is the blurring processing described above, for example.

It should be noted that the pieces of filter processing Fa and Fb are not limited to the above. For example, the filter processing Fa may be the blurring processing, and the filter processing Fb may be the sharpening filter processing. That is, one of the pieces of filter processing Fa and Fb is the blurring processing.

In addition, the filter processing Fa or the filter processing Fb may be processing that emphasizes edges, which is different from the sharpening filter processing.

As described above, according to the present modification, the filtering processing with different characteristics is performed on each of the superimposing portion Gae and the superimposing portion Gbe. Thus, the same effect as of the first embodiment can be obtained. That is, even if misalignment of the printed positions of the images Gwa and Gwb occurs, it is possible to suppress the occurrence of a low image quality portion (streak) in the superimposing region Rw of the panoramic image Gw in the superimposition printed state. Furthermore, it is possible to make the density step (joint) at the leading edge and the trailing edge of the superimposing region Rw inconspicuous.

### Second Embodiment

Hereinafter, the configuration of the second embodiment is also referred to as “configuration Ct2”. A low image quality portion (streaks, unevenness) that occurs when there is misalignment in the printed positions of the images Gwa and Gwb may differ in appearance depending on the frequency component of the superimposing portion. When the frequency component of the superimposing portion includes a high frequency component, the low image quality portion can be easily seen.

In the first embodiment, the blurring processing is performed on the superimposing portion. It should be noted that when the blurring processing with a large blurring degree is performed on the superimposing portion, the sharpness of the superimposing portion decreases. Therefore, it is not preferable to simply perform the blurring processing with a large blurring degree.

Thus, the configuration Ct2 is a configuration of changing the filter processing according to the frequency components included in the superimposing portion. For example, when there is a strong possibility that a low image quality portion will occur, the blurring processing with a large blurring degree is performed.

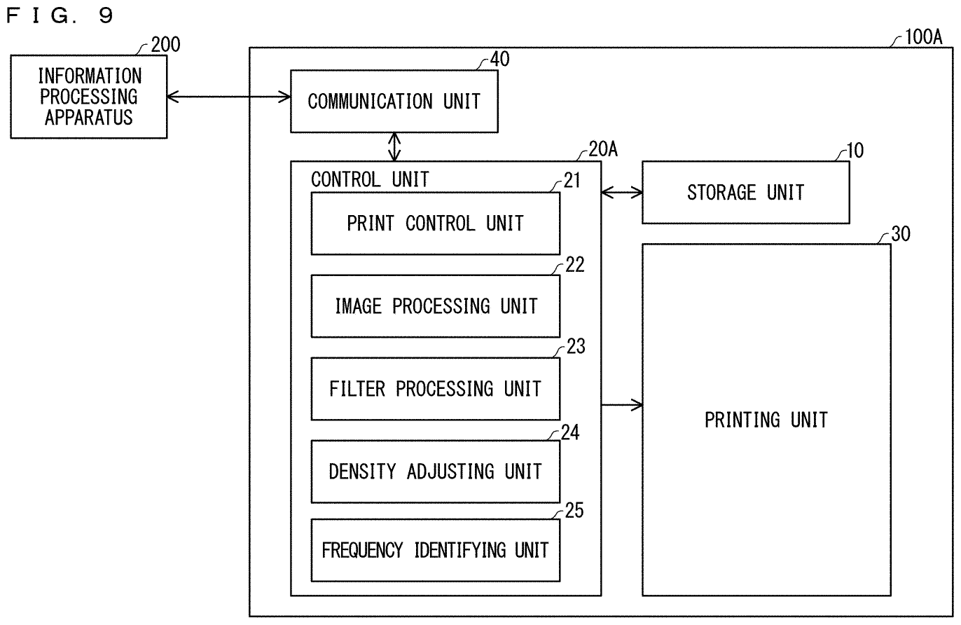

FIG. 9 is a block diagram showing a main configuration of a thermal transfer printer 100A according to the second embodiment. The thermal transfer printer 100A is different from the thermal transfer printer 100 in FIG. 1 in that a control unit 20A is included instead of the control unit 20. Since the configuration and function of the thermal transfer printer 100A other than that are the same as those of the thermal transfer printer 100, detailed description will not be repeated.

The control unit 20A differs from the control unit 20 in further including a frequency identifying unit 25. Since the configuration and function of the control unit 20A other than those are the same as those of the control unit 20, detailed description will not be repeated.

The frequency identifying unit 25 is a program module executed by the control unit 20, for example. In other words, the frequency identifying unit 25 is achieved by the control unit 20 performing various kinds of processing according to the programs stored in the memory or the like. It should be noted that the frequency identifying unit 25 may include a signal processing circuit configured by a hardware electric circuit.

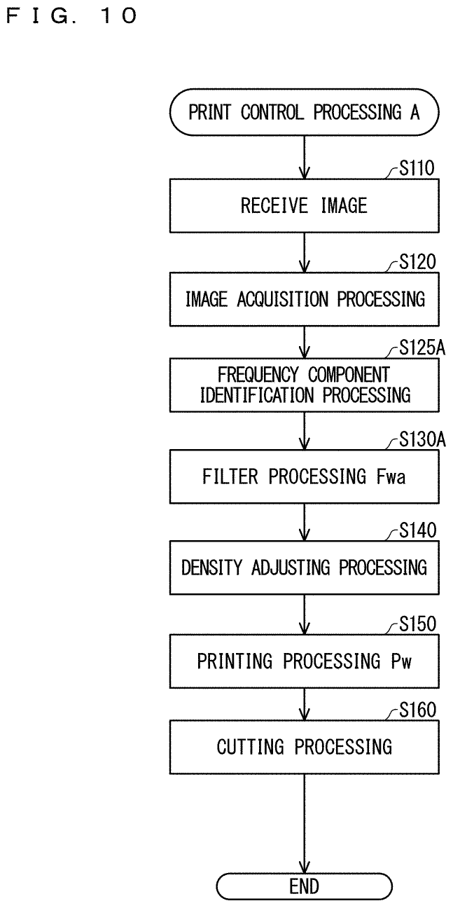

Next, processing performed by the thermal transfer printer 100A (hereinafter, also referred to as “print control processing A”) will be described. FIG. 10 is a flowchart of the print control processing A according to the second embodiment. In FIG. 10, since the processing in the step number same as the step number in FIG. 5 is performed in the same manner as the processing described in the first embodiment, the detailed description will not be repeated. In the following, points different from those in the first embodiment will be mainly described.

Here, the following premise Pm3 is considered. On the premise Pm3, the information processing apparatus 200 transmits the print instructions and the image data D1 indicating the panoramic image Gw in FIG. 6A to the thermal transfer printer 100.

In the print control processing A on the premise Pm3, the processing of steps S110 and S120 is performed as in the first embodiment.

Next, in step S125A, frequency component identification processing is performed. In the frequency component identification processing, the frequency identifying unit 25 identifies (analyzes) the frequency component included in at least one of the superimposing portion Gae and the superimposing portion Gbe. Since the identification (analysis) of the frequency component is a well-known technique performed by using, for example, two-dimensional Fourier transform, detailed description thereof will be omitted. In the following, a brief description will be given.

The frequency identifying unit 25 performs a two-dimensional Fourier transform on the superimposing portion Gae, thereby obtaining the spatial frequency spectrum included in the superimposing portion Gae. The frequency identifying unit 25 identifies the frequency component included in the superimposing portion Gae based on the spatial frequency spectrum.

At the time when the frequency component identification process is performed, the superimposing portion Gbe has the same image as the superimposing portion Gae, so that the frequency component included in the superimposing portion Gae is the same as the frequency component included in the superimposing portion Gbe. Therefore, the frequency identifying unit 25 identifies the frequency component included in the superimposing portion Gae, thereby identifying the frequency component included in the superimposing portion Gbe.

It should be noted that in the frequency component identification processing, the frequency identifying unit 25 may identify the frequency component included in only one of the superimposing portions Gae and Gbe.

Next, in step S130A, filter processing Fwa is performed. In the filter processing Fwa, the filter processing unit 23 performs filter processing based on an identified frequency component (spatial frequency spectrum).

Hereinafter, the reference frequency in the spatial frequency spectrum is also referred to as “reference frequency Fm”. The reference frequency Fm is a predetermined frequency. In the present embodiment, as an example, the frequency being 0.5 times the maximum frequency that the spatial frequency spectrum can represent is the reference frequency Fm.

For example, assume that the identified frequency component (spatial frequency spectrum) includes a high frequency component higher than the reference frequency Fm. In this case, since it is likely that the low image quality portion occurs, the filter processing unit 23 performs filter processing of reducing the sharpness of the image on the superimposing portion Gae and the superimposing portion Gbe. The filter processing is blurring processing with a large blurring degree.

For example, assume that the identified frequency component (spatial frequency spectrum) does not include the above high frequency component, and includes a low frequency component not more than the reference frequency Fm. In this case, since it is less likely that the low image quality portion occurs, the filter processing unit 23 performs filter processing of hardly reducing the sharpness of the image on the superimposing portion Gae and the superimposing portion Gbe. The filter processing is blurring processing with a small blurring degree.

It should be noted that in the filter processing Fwa, the filter processing unit 23 may perform, on the superimposing portion Gae and the superimposing portion Gbe, the blurring processing in which the higher the frequency included in the identified frequency component (spatial frequency spectrum), the greater the blurring degree.

After processing of the filter processing Fwa, the processing in steps S140, S150, and S160 is performed as in the first embodiment.

As described above, according to the present embodiment, the frequency identifying unit 25 identifies (analyzes) the frequency component included in at least one of the superimposing portion Gae and the superimposing portion Gbe. The filter processing unit 23 performs the filter processing based on the identified frequency component. Thus, even if misalignment of the printed positions of the images Gwa and Gwb occurs, it is possible to suppress that a low image quality portion (streaks, unevenness) is generated in the superimposing region Rw of the panoramic image Gw in the superimposition printed state without reducing the sharpness of the image as much as possible. That is, it is possible to obtain an effect that a high quality print can be stably obtained.

(Functional Block Diagram)

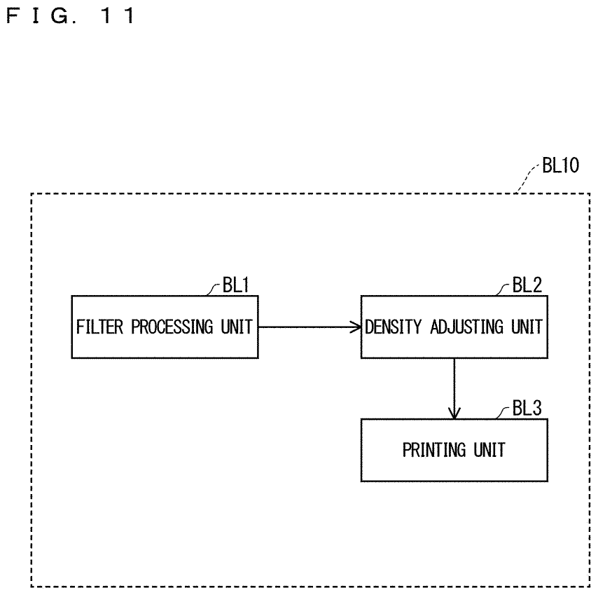

FIG. 11 is a block diagram illustrating a characteristic functional configuration of a thermal transfer printer BL10. The thermal transfer printer BL10 corresponds to any one of the thermal transfer printer 100 and the thermal transfer printer 100A. In other words, FIG. 11 is a block diagram illustrating main functions related to the present invention, among the functions of the thermal transfer printer BL10.

Using an ink sheet, the thermal transfer printer BL10 performs printing processing of printing a panoramic image represented by a plurality of images including a first image and a second image on paper.

The first image has a first superimposing portion being a rear end portion of the first image. The second image has a second superimposing portion being a front end portion of the second image. The panoramic image is represented by at least the first image and the second image in a situation where the second superimposing portion is superimposed on the first superimposing portion.

The thermal transfer printer functionally includes a filter processing unit BL1, a density adjusting unit BL2, and a printing unit BL3.

The filter processing unit BL1 performs filter processing on the first superimposing portion and the second superimposing portion. The filter processing unit BL1 corresponds to the filter processing unit 23.

The density adjusting unit BL2 performs, on the first superimposing portion and the second superimposing portion, density processing of adjusting the density of the first superimposing portion on which the filter processing has been performed and the density of the second superimposing portion on which the filter processing has been performed. The density adjusting unit BL2 corresponds to the density adjusting unit 24.

The printing unit BL3 performs the printing processing of printing the panoramic image to be represented by at least the first image and the second image on the paper in a situation where the second superimposing portion on which the density processing has been performed is superimposed on the first superimposing portion on which the density processing is performed. The printing unit BL3 corresponds to the printing unit 30.

The panoramic image has a superimposing region. The superimposing region is a region for superimposing the second superimposing portion on the first superimposing portion.

The filter processing is processing for reducing change in image quality of the superimposing region occurring in a situation where the panoramic image is to be printed on the paper and a situation where the second superimposing portion overlaps the first superimposing portion in a misaligned manner

(Other Modifications)

As described above, the thermal transfer printer according to the present invention has been described based on each of the embodiments and a modification, but the present invention is not limited to each of the embodiments and the modification. Without departing from the gist of the present invention, those obtained by performing modifications conceived by those skilled in the art on each embodiment and the modification are also included in the present invention. In other words, in the present invention, each of the embodiments and the modification can be freely combined, and each of the embodiments and the modification can be appropriately modified or omitted within the scope of the present invention.

Hereinafter, the thermal transfer printer according to the present invention is also referred to as “thermal transfer printer hzs”. The thermal transfer printer hzs is any one of the thermal transfer printers 100 and 100A.

In addition, the thermal transfer printer hzs does not need to include all the components shown in the drawings. That is, the thermal transfer printer hzs has only to include only the minimum components that can achieve the effects of the present invention.

In addition, each function of the filter processing unit 23 and the density adjusting unit 24 included in the thermal transfer printer hzs may be achieved by a processing circuit.

The processing circuit is a circuit for performing filter processing on the first superimposing portion and the second superimposing portion.

In addition, the processing circuit is also a circuit for performing, on the first superimposing portion and the second superimposing portion, density processing of adjusting the density of the first superimposing portion on which the filter processing has been performed and the density of the second superimposing portion on which the filter processing has been performed.

The filter processing is processing for reducing change in image quality of the superimposing region occurring in a situation where the panoramic image is to be printed on the paper and a situation where the second superimposing portion overlaps the first superimposing portion in a misaligned manner.

The processing circuit may be dedicated hardware. In addition, the processing circuit may be a processor that executes a program stored in a memory. The processor is, for example, a central processing unit (CPU), a central processing apparatus, an arithmetic apparatus, a microprocessor, a microcomputer, a digital signal processor (DSP), or the like.

Hereinafter, a configuration in which the processing circuit is dedicated hardware is also referred to as “configuration Cs1”. In addition, hereinafter, a configuration in which the processing circuit is a processor is also referred to as “configuration Cs2”. In addition, hereinafter, a configuration in which a function of each of the filter processing unit 23 and the density adjusting unit 24 is achieved by a combination of hardware and software is also referred to as “configuration Cs3”.

In the configuration Cs1, a single circuit, a composite circuit, a programmed processor, a parallel programmed processor, an application specific integrated circuit (ASIC), a field programmable gate array (FPGA), or a combination thereof corresponds to the processing circuit, for example. The functions of the filter processing unit 23 and the density adjusting unit 24 may be achieved by two respective processing circuits. In addition, all the functions of the filter processing unit 23 and the density adjusting unit 24 may be achieved by one processing circuit.

It should be noted that a configuration in which all or a part of each component included in the thermal transfer printer hzs is represented by hardware is as follows, for example. Hereinafter, a thermal transfer printer in which all or a part of each component included in the thermal transfer printer hzs is represented by hardware is also referred to as “thermal transfer printer hd10”.

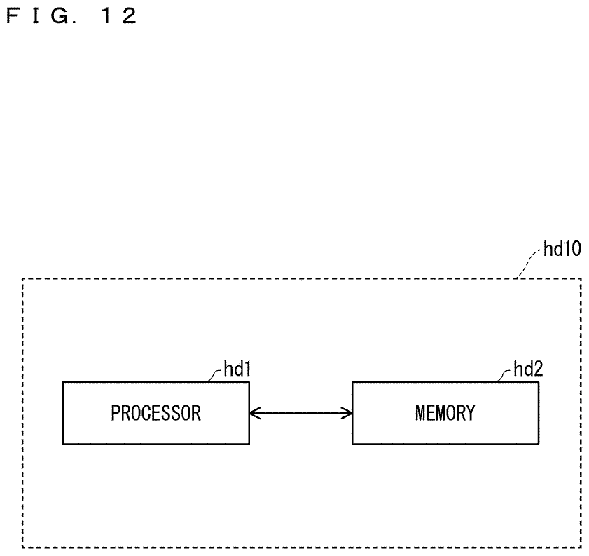

FIG. 12 is a hardware configuration diagram of the thermal transfer printer hd10. With reference to FIG. 12, the thermal transfer printer hd10 includes a processor hd1 and a memory hd2. The memory hd2 is a nonvolatile or volatile semiconductor memory such as a random access memory (RAM), a read only memory (ROM), a flash memory, an EPROM, and an EEPROM. In addition, the memory hd2 is, for example, a magnetic disk, a flexible disk, an optical disc, a compact disc, a mini disc, a DVD, or the like. In addition, the memory hd2 may be any storage medium to be used in the future.

In the configuration Cs2, the processing circuit is the processor hd1. In the configuration Cs2, a function of each of the filter processing unit 23 and the density adjusting unit 24 is achieved by software, firmware, or a combination of software and firmware. The software or firmware is described as a program and stored in the memory hd2.

In addition, in the configuration Cs2, reading the program stored in the memory hd2 and executing the program, by the processing circuit (processor hd1), achieves a function of each of the filter processing unit 23 and the density adjusting unit 24. That is, the memory hd2 stores the following program.

The program is a program for causing the processing circuit (processor hd1) to execute the step of performing the filter processing on the first superimposing portion and the second superimposing portion.

In addition, the program is also a program for causing the processing circuit (processor hd1) to execute the step of performing, on the first superimposing portion and the second superimposing portion, density processing for adjusting the density of the first superimposing portion on which the filter processing has been performed and the density of the second superimposing portion on which the filter processing has been performed.

The filter processing is processing for reducing change in image quality of the superimposing region occurring in a situation where the panoramic image is to be printed on the paper and a situation where the second superimposing portion overlaps the first superimposing portion in a misaligned manner.

In addition, the program also causes a computer to execute a procedure of processing performed by each of the filter processing unit 23 and the density adjusting unit 24, a method of performing the processing, and the like.

In the configuration Cs3, part of functions of the filter processing unit 23 and the density adjusting unit 24 are achieved by dedicated hardware. In addition, in the configuration Cs3, another part of the functions of the filter processing unit 23 and the density adjusting unit 24 are achieved by software or firmware.

For example, the function of the filter processing unit 23 is achieved by the processing circuit reading and executing a program stored in the memory. In addition, for example, the function of the density adjusting unit 24 is achieved by a processing circuit as dedicated hardware.

As in the above configuration Cs1, configuration Cs2, and configuration Cs3, the processing circuit can achieve each function described above by hardware, software, firmware, or a combination thereof.

In addition, the present invention may be achieved as a printing method in which the operations of characteristic components included in the thermal transfer printer hzs are performed as steps. In addition, the present invention may be achieved as a program that causes a computer to execute each step included in the printing method. In addition, the present invention may be achieved as a computer-readable recording medium that stores the program. In addition, the program may be delivered via a transmission medium such as the Internet.

In addition, the printing method according to the present invention corresponds to the print control processing in FIG. 5 or the print control processing A in FIG. 10, for example.

All the numerical values used in the above embodiments are exemplary numerical values for specifically describing the present invention. That is, the present invention is not limited to each of the numerical values used in the above embodiments.

It should be noted that in the present invention, each of the embodiments and the modification can be freely combined, and each of the embodiments and the modification can be appropriately modified or omitted within the scope of the present invention.

For example, in each above embodiment, the ink ribbon provided with the protective material 6op is used, but the present invention is not limited to this. In each above embodiment, an ink ribbon provided with no protective material 6op may be used.

Although the present invention is described in detail, the above description is in all aspects illustrative, and the present invention is not limited to the above description. It is understood that innumerable modifications not illustrated can be envisaged without departing from the scope of the present invention.

### EXPLANATION OF REFERENCE SIGNS

2: paper
6: ink sheet
23, BL1: filter processing unit
24, BL2: density adjusting unit
25: frequency identifying unit
30, BL3: printing unit
100, 100A, BL10, hd10, hzs: thermal transfer printer

1. A thermal transfer printer configured to perform printing processing of printing, on paper, a panoramic image to be represented by a plurality of images including a first image and a second image using an ink sheet,
wherein the first image has a first superimposing portion being a rear end portion of the first image,
the second image has a second superimposing portion being a front end portion of the second image,
the panoramic image is represented by at least the first image and the second image in a situation where the second superimposing portion is superimposed on the first superimposing portion,
the thermal transfer printer comprising:
a processor to execute a program; and
a memory to store the program which, when executed by the processor, performs,
filter processing on the first superimposing portion and the second superimposing portion;
on the first superimposing portion and the second superimposing portion, density processing of adjusting density of the first superimposing portion on which the filter processing is performed and density of the second superimposing portion on which the filter processing is performed; and
the printing processing of printing, on the paper, the panoramic image to be represented by at least the first image and the second image in a situation where the second superimposing portion on which the density processing is performed is superimposed on the first superimposing portion on which the density processing is performed,
wherein the panoramic image has a superimposing region,
the superimposing region is a region for superimposing the second superimposing portion on the first superimposing portion, and
the filter processing is processing configured to reduce change in image quality of the superimposing region occurring in a situation where the panoramic image is printed on the paper and a situation where the second superimposing portion overlaps the first superimposing portion in a misaligned manner.

2. The thermal transfer printer according to claim 1, wherein the processor performs, on the first superimposing portion and the second superimposing portion, the density processing for reducing density change in the superimposing region occurring when the second superimposing portion on which the filter processing is performed is superimposed on the first superimposing portion on which the filter processing is performed.

3. The thermal transfer printer according to claim 1, wherein each of the filter processing performed on the first superimposing portion as an image and the filter processing performed on the second superimposing portion as the image is blurring processing configured to reduce sharpness of the image.

4. The thermal transfer printer according to claim 1, wherein a characteristic of the filter processing performed by the processor on the first superimposing portion and a characteristic of the filter processing performed by the processor on the second superimposing portion are different from each other.

5. The thermal transfer printer according to claim 4, wherein one of the filter processing performed on the first superimposing portion as an image and the filter processing performed on the second superimposing portion as the image is blurring processing configured to reduce sharpness of the image.

6. The thermal transfer printer according to claim 1, wherein the processor identifies a frequency component included in at least one of the first superimposing portion and the second superimposing portion, performs the filter processing based on the frequency component identified.

7. The thermal transfer printer according to claim 6, wherein when the frequency component identified includes a high frequency component higher than a predetermined frequency, the processor performs the filter processing configured to reduce sharpness of the image on the first superimposing portion and the second superimposing portion as an image.

8. A printing method to perform printing processing of printing, on paper, a panoramic image to be represented by a plurality of images including a first image and a second image using an ink sheet,
wherein the first image has a first superimposing portion being a rear end portion of the first image,
the second image has a second superimposing portion being a front end portion of the second image,
the panoramic image is represented by at least the first image and the second image in a situation where the second superimposing portion is superimposed on the first superimposing portion,
the printing method comprising:
performing filter processing on the first superimposing portion and the second superimposing portion;
performing, on the first superimposing portion and the second superimposing portion, density processing of adjusting density of the first superimposing portion on which the filter processing is performed and density of the second superimposing portion on which the filter processing is performed; and
performing the printing processing of printing, on the paper, the panoramic image to be represented by at least the first image and the second image in a situation where the second superimposing portion on which the density processing is performed is superimposed on the first superimposing portion on which the density processing is performed,
wherein the panoramic image has a superimposing region,
the superimposing region is a region for superimposing the second superimposing portion on the first superimposing portion, and
the filter processing is processing configured to reduce change in image quality of the superimposing region occurring in a situation where the panoramic image is printed on the paper and a situation where the second superimposing portion overlaps the first superimposing portion in a misaligned manner.
